(19) United States
(12) Patent Application Publication
(10) Pub. No.: US 2017/0054261 A1
(43) Pub. Date: Feb. 23, 2017

(54) Low Loss Shielded Cable Splice Ferrule System

(71) Applicants: Oliviu Muja, Lexington Park, MD (US); Jacklyn Duff, Blue Bell, PA (US)

(72) Inventors: Oliviu Muja, Lexington Park, MD (US); Jacklyn Duff, Blue Bell, PA (US)

(73) Assignee: United States of America as represented by the Secretary of the Navy, Patuxent River, MD (US)

(21) Appl. No.: 14/832,312

(22) Filed: Aug. 21, 2015

(51) Int. Cl. H01R 43/048

(52) U.S. Cl. CPC H01R 43/048

(57) ABSTRACT

This invention relates generally to connectors for wiring applications, more specifically, to a low signal loss (low impedance), shielded cable splice crimp ferrule system. A precision sized splice crimp ferrule is installed using a standard hand crimp tool with an associated symmetrical geometry die and positioner. When employed with other components to terminate the dielectric and the metallic shield over the metallic braid of a cable, the splice crimp ferrule system results in a low signal loss, shielded cable repair that can be used in many types of cable systems.

### STATEMENT OF GOVERNMENT INTEREST

The invention described herein may he manufactured and used by, or for the Government of the United States of America, for governmental purposes without payment of any royalties thereon or therefore.

### BACKGROUND

Current methods of splicing together class 1 shielded cables require the use of environmentally resistant splices with crimp ferrules to splice the center conductors. These crimp ferrules incorporate a large, notched inspection window/hole for the visual inspection of the crimped wire ends. A metallic braided sleeve is used to provide a shielding effect for the cable splice. A solder sleeve is melted to each braided end of the shielded cables to provide a braid to braid connection for electrical continuity. Heat shrink tubing is placed around the spliced area to environmentally seal off the spliced shielded cable.

Current methods employ a coaxial cable splice kit. This kit is made up of components, which when installed, become a long, rigid repair with a fluorocarbon-based thermoplastic outer jacket. The outer jacket also contains a pre-tinned metallic braid insert, which covers and shields the center conductor insulated splice. Because of its rigidity and length, this splice repair cannot be installed in curved cable applications and is subject to fracture. Additionally, it does not maintain the performance of the cable's dielectric insulator. Its performance frequency range is limited to 3 GHz with an allowable insertion loss of approximately 1 dB increase and a return loss of approximately 2 dB. These types of splices are only available for coaxial Radio Frequency (RF) cables with lower frequency operating requirements. However, commonly used cables such as the RG400 and RG393 operate at frequencies over 11 GHz. Splicing these cables with the existing splices induces significant signal loss, adversely impacting system performance.

Consequently, while present splice kits and methods are sufficient for splicing together lower frequency coaxial cables, they have excessive signal loss on the higher performance cables. With increased operational frequency requirements, there is an increase in signal loss, directly affecting system performance. In many instances, the resulting degradation in system performance due to signal loss is so great that cables cannot be spliced at all. The result is time consuming maintenance actions to replace entire lengths of coaxial cable containing the damage. Moreover, impedance matched shielded cables are installed with as few connectors as possible to reduce signal loss. This results in very long cable lengths. If these long coaxial cables cannot be permanently repaired, the entire length has to be replaced resulting in extensive costs for time, parts, and labor.

Therefore, what is needed is a low loss splice capable of permanently repairing a range of damaged shielded cables as required in various applications.

### SUMMARY

Disclosed, is a system for splicing the metallic center conductor of a cable comprising a ferrule and a two piece die for crimping the ferrule. This system addresses the splicing of the center conductor for the repair of an RF, coaxial, or triaxial cable and the like. The remaining portions of the cable's repair, such as: dielectric insulator, metallic shield and outer environmental jacket, are not part of this invention. The system disclosed is comprised of two components, a precision dimensioned crimp ferrule, specially designed for the applicable coaxial cable types, and a two piece die which is used to mechanically crimp the ferrules. Each crimp ferrule size has a designated crimp die configuration for its crimping.

The crimp ferrule is a two ended, annealed cylindrical ferrule. It is tube shaped, with chamfered inner surfaces at 45 degrees at each end. It is marked with an identification band. The crimp ferrule is precision dimensioned. Once crimped, the ferrule has a symmetrical, hexagonal shape and cross-sectional diameter, which reduces signal loss. The crimp ferrule was developed in six common sizes; 12, 20, 22, 23, 24, and 28 AWG (American Wire Gauge). However, the design can also be applied to other sizes and gauges to achieve similar results.

Each of the crimp die sets is comprised of two halves. Two configurations of the crimp die sets were developed for the cited crimp ferrules. The first half has an inner crimping surface with a half symmetrical, hexagonal cutout to accommodate half of the crimp ferrule and metallic center conductor of a cable for crimping. The first half of the die also has an outer tooled surface for engagement with the designated crimp tool.

The second half of the die also has a symmetrical, hexagonal cutout to accommodate the other half of the crimp ferrule and metallic center conductor for crimping. The second half of the die also has an outer tooled surface for engagement with a crimping tool. Additionally, the second half of the die includes a notched locator for securing the crimp ferrule, while crimping. It contains a cavity of the correct size to match the diameter of the cable it was designed to accommodate for splicing. The notched locator also has a rest cutout to accommodate the dielectric of the cable being crimped. Moreover, the inner crimping surface of the second half of the die fits flush against the inner crimping surface of the first half of the die to reduce air gaps between the crimped ferrule and the insulating cable dielectric, thus it is designed to improve both electrical and mechanical performance of the splice repair of the cable.

The features, aspects and advantages of the present invention are shown with reference to the following description, appended claims, and accompanying drawings wherein:

### DRAWINGS

FIG. 1 is a perspective view of the crimp ferrule before it is installed onto the two ends of the coaxial cable.

FIG. 2 is a cross sectional detailed view of the crimp ferrule.

FIG. 2A is a cross sectional view of an end of the crimp ferrule prior to crimping.

FIG. 3 is a perspective view of the crimp ferrule after it is crimped using the associated crimp die.

FIG. 3A is a cross sectional perspective view an end of the crimp ferrule after it is crimped.

FIG. 4 is a perspective view of the crimp ferrule after it is crimped onto a coaxial cable for repair.

FIG. 5 shows a perspective front view of the crimp die.

FIG. 6 shows a perspective side view of the crimp die.

FIG. 7 shows a perspective front view of the crimp die with a notched locator.

FIG. 8 shows a perspective side view of the crimp die with the notched locator.

FIG. 9 shows a perspective rear view of the crimp die with the notched locator.

FIG. 10 shows a perspective side view of the notched locator.

FIG. 11 shows a front view perspective of an embodiment of a larger configuration of the crimp die.

FIG. 12 shows a side view perspective of an embodiment of a larger configuration of the crimp die.

FIG. 13 shows a rear view perspective of the larger embodiment of the crimp die.

FIG. 14 shows a side view perspective of the notched locator.

### DETAILED DESCRIPTION

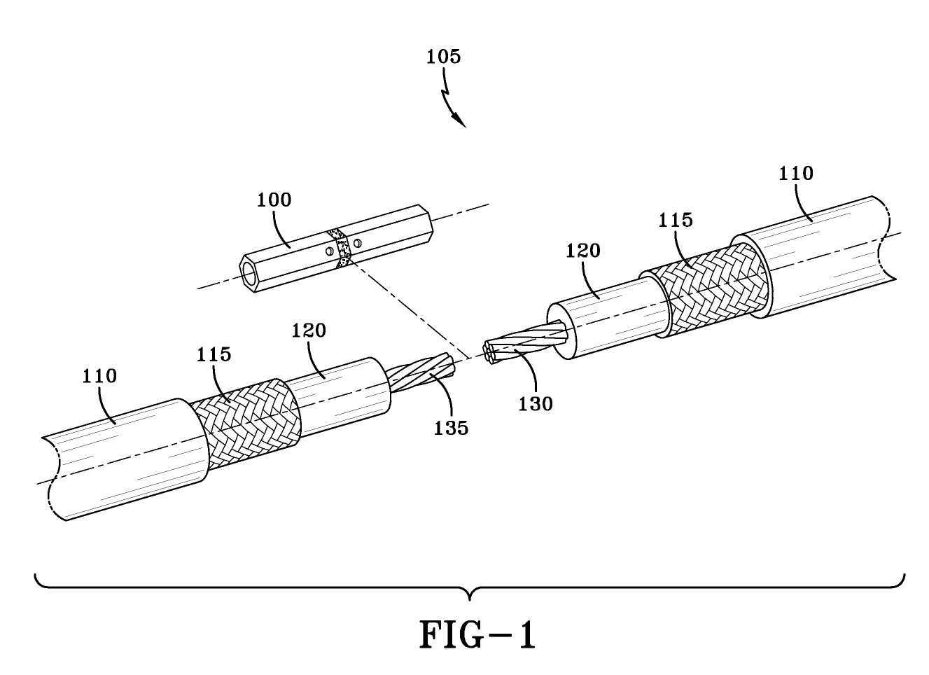

In the following description of the present invention, reference will be made to various embodiments which are not meant to be all inclusive. The current invention can be implemented using various configurations in a variety of sizes and materials while still embodying the invention. The preferred embodiments of the present invention are illustrated by way of example below and in FIGS. 1-14.

FIG. 1 is an embodiment of a typical installation of the crimp ferrule (100), before it is installed onto a standard coaxial cable (105). The coaxial cable (105) is readied for repair with the damaged sections removed. The outer cable jacket (110) protects the metallic shielding layer (115) directly below it, which, in turn, covers the dielectric insulator (120). The metallic center conductor (130 and 135) is the inner most layer of the cable (105) and the part to be repaired by the current invention. The crimp ferrule (100) is used to join the two ends of the metallic center conductor (130 and 135). Once the crimp ferrule (100) is crimped onto the ends of the metallic center conductor (130 and 135), they will be permanently, electrically, and mechanically joined resulting in a gas free, void free, low signal loss connection. The crimp ferrule (100) can be applied to cables in a variety of gauge sizes.

FIG. 2 shows a detailed cross sectional view of an embodiment of the crimp ferrule (200). The crimp ferrule (200) is tube shaped and is chamfered to 45 degrees at each end (205 and 210) to enable easier wire insertion. In the present embodiment, the crimp ferrule (200) is manufactured with annealed copper meeting industry standards. However, other materials can be employed. Also, to optimize electrical conductivity and corrosion protection, the present embodiment of the crimp ferrule (200) is gold plated in accordance with MIL-G-45204, type II, grade C, class 1 (0.000050 minimum) over a suitable under plate. To enable the installer to see the wire strands on both ends of the center conductor, and ensure that minimum wire insertion is achieved, the present embodiment of the crimp ferrule (200) is equipped with two optional inspection holes (215) close to the longitudinal center of the crimp ferrule (200). In alternate embodiments of the crimp ferrule (200), the inspection holes (215) can be omitted. Also, the crimp ferrule (200) contains a smooth inner bore throughout its entire length as shown in FIG. 2A.

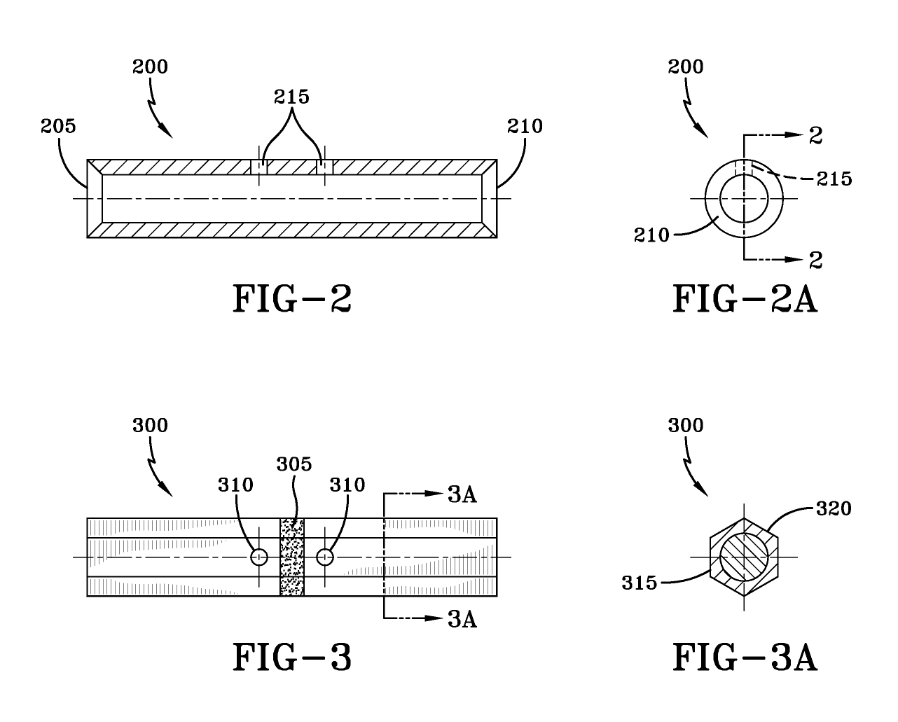

FIG. 3 shows a perspective view of an alternate embodiment of the crimp ferrule (300) after it is crimped, with a color band (305) applied axially at the center of the crimp ferrule to identify and delineate the size of the crimp ferrule. A system of color bands can be used to correspond to various crimp ferrule sizes so that the correct size can be identified and used for crimping. The crimp ferrule embodiment in FIG. 3 also employs optional inspection holes 310, which can be employed to view the proper center conductor insertion depth into the camp ferrule prior to crimping. After crimping, the crimp ferrule (300) has a symmetrical, hexagonal geometry imposed by the crimp die as shown in FIG. 3A. Crimping creates exposed longitudinal flat sides (315 and 320), for example). The asymmetrical hexagonal geometry of the crimp ferrule, along with the ability to size the splice longitudinally and axially in the crimp ferrule, allows one to reduce the size of the splice, optimize the fit, improve electrical performance and reduce signal loss by achieving a gas free and void free metallic, electrical joint.

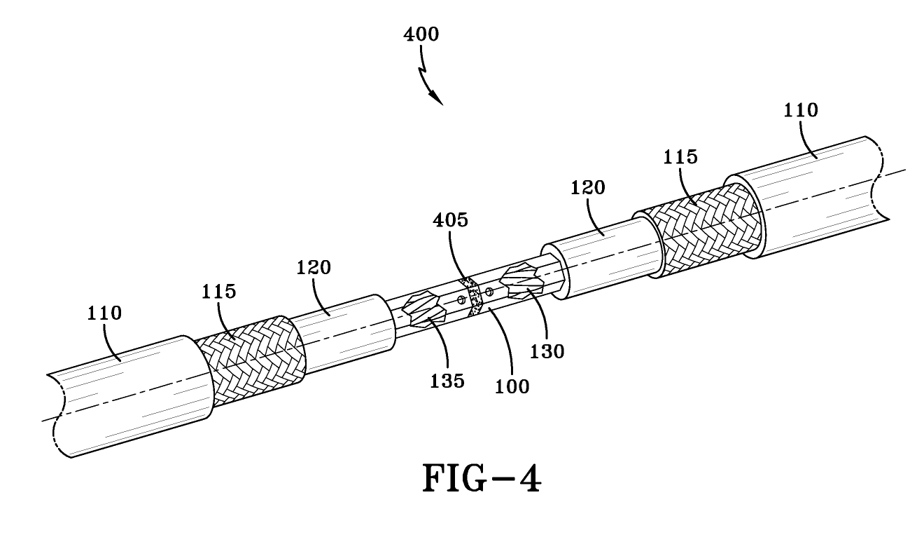

FIG. 4 shows a view of an embodiment of the crimp ferrule (400) after it is installed and crimped onto a typical coaxial cable. This embodiment of the crimp ferrule (400) is shown without inspection holes. The center identification color band (405) is visible even after crimping.

The splice crimp ferrule is installed using one of the two sets of crimp dies which are configured with standard tool interfaces, so that it can be used with existing larger or smaller crimp tools, complying with industry and/military standards. The dimensions and configuration of the crimp nest geometry on the inner surface of the crimp die is sized to accommodate various wire gauge sizes such as 12, 20, 22, 23, 24 and 28 to address most coaxial, triaxial and twin axial cable applications. The crimp die sets can incorporate single, or multiple crimp nests based on the size crimp ferrule to be crimped.

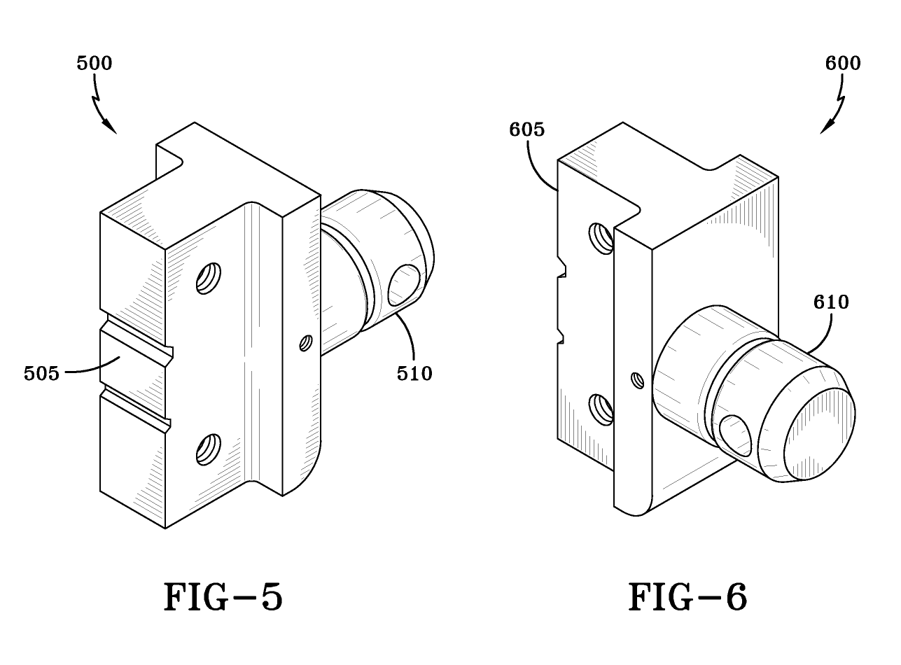

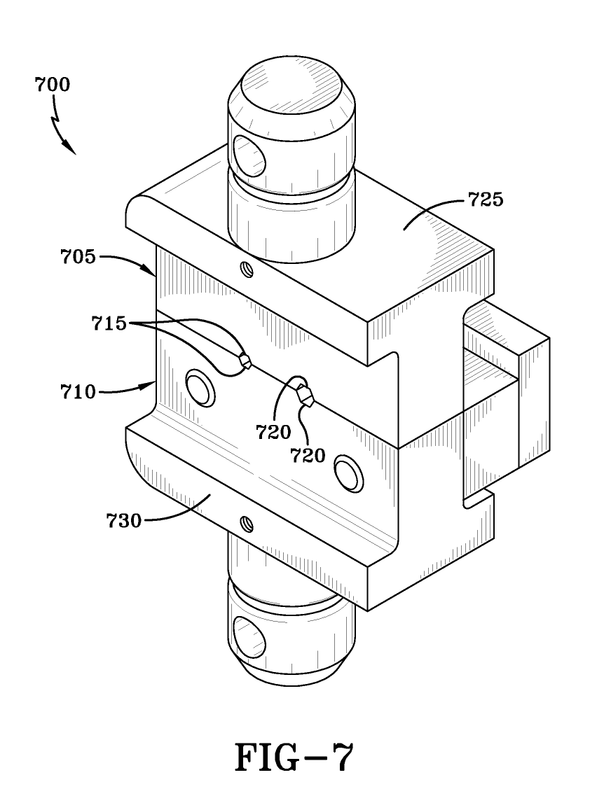

Referring to FIG. 5, a perspective front view of the crimp die is shown. A crimp section end of the die (505) is shown as a reference to orientation. The tool interface portion (510) of the crimp die slides or clips into existing crimp frame configurations. This tooled end section can be designed to fit other crimping tool embodiments.

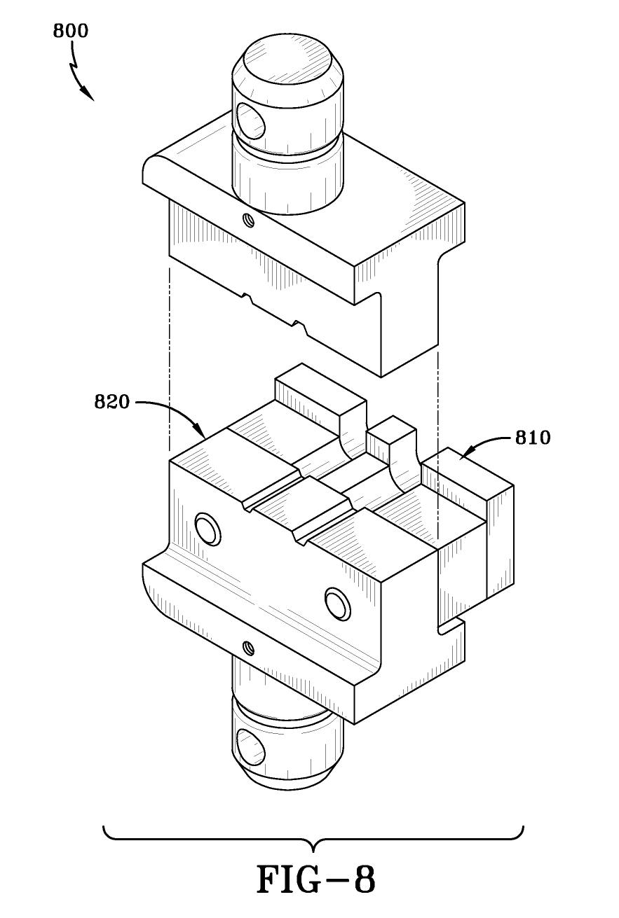

FIG. 6 shows and alternate side view perspective of the crimp die which interfaces with the tool. The tool interface end section (610) of the die is shown.

FIG. 7 shows a front view of an embodiment of the crimp die 700. The two halves (705 and 710) of the die align and fit together to crimp the ferrules. The inner surface of each half of the crimp die (705 and 710) has one half of a symmetrical, hexagonal cutout (715) also shown in FIG. 8, (see (820)). When aligned and pressed together the die halves (705 and 710) create a symmetrical, hexagonal crimp nest (715 and 720) to accommodate the crimp ferrule. The die in FIG. 7 has two different sized crimp nests. The smaller crimp nest (715) accommodates the 22, 23, 24 and 28 AWG size crimp ferrules and the larger crimp nest (720) accommodates the 20 AWG size crimp ferrule. The end tooled portions (730 and 725) fit into the crimp tool.

FIG. 8 is a side view perspective of an embodiment of the crimp die (800). The die includes a notched cable positioner (810) for securing the crimp ferrule in place while to crimping. The notched cable positioner (810) enables at least a 4% overlap of the ends of the metal conductor. This overlap is required for longitudinal alignment and symmetry. The center line of the crimp surface and the center of the crimp ferrule (820) align when the die is fully engaged (i.e. both halves are mechanically pressed together).

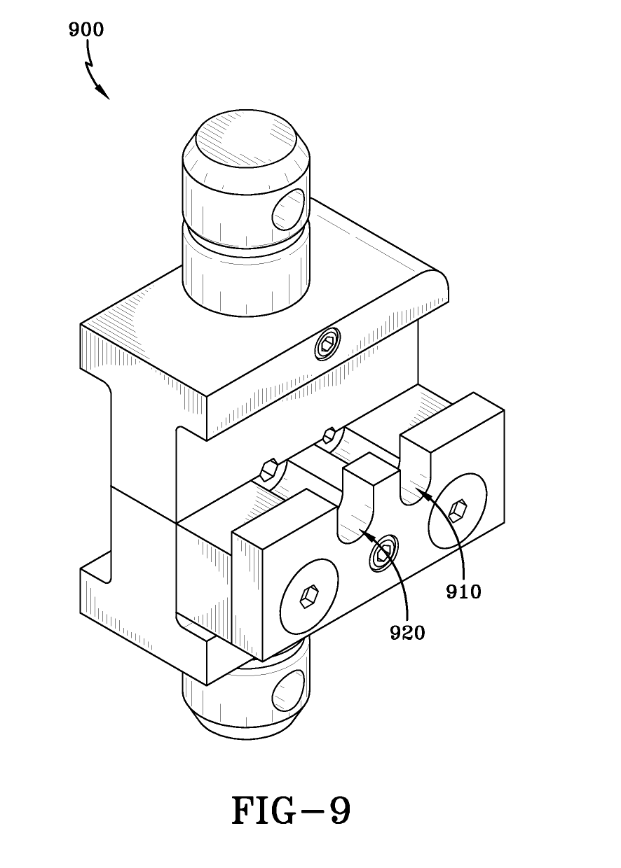

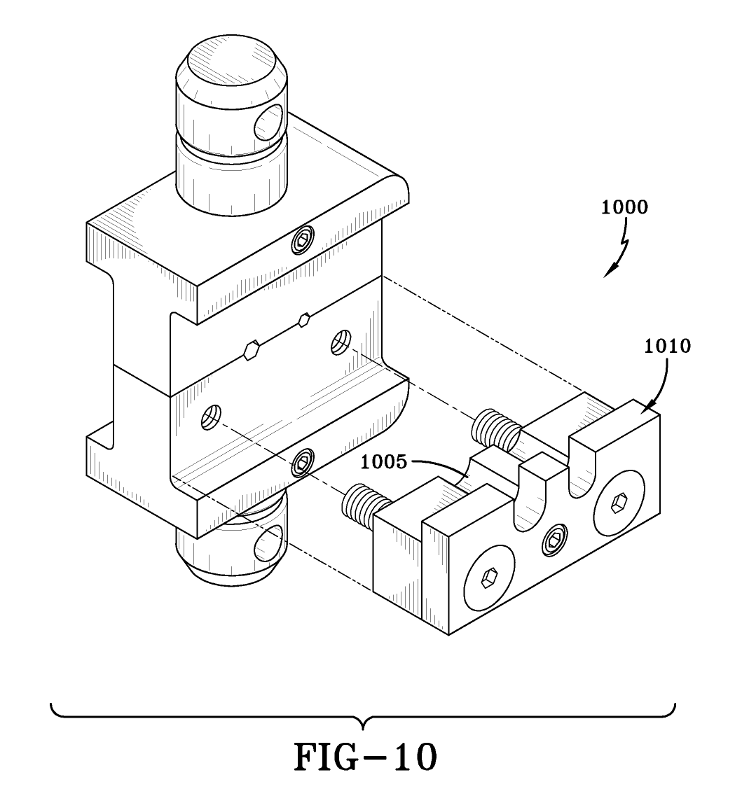

In FIG. 9, a side view of the crimp die (900) is shown. Items (910) and (920) are different sized notched cable locators against which the crimp ferrule rests when getting crimped. The bored sizes of the two notched cable locators are dimensioned to accommodate the correct size of the dielectric insulator. The die set (900) has a machine tool finish to prevent corrosion and is precision polished on its inner crimp surfaces to ensure a smooth and uniform crimp ferrule surface.

Referring to FIG. 10 a side view perspective of the notched cable locator (1000) is shown separately from the crimp die. The die includes a notched cable locator (1010) for securing the ferrule and cable in place while crimping. The notched cable locator (1010), along with the correct dimension of the crimp interface, enables at least a 4% overlap of the ends of the crimp ferrule. This overlap is required for longitudinal alignment and symmetry. Item (1005) shows the area where the crimp ferrule rests as it is being crimped. Item (1010) is the position stop gate against which the crimp ferrule rests and the cable is positioned while being crimped.

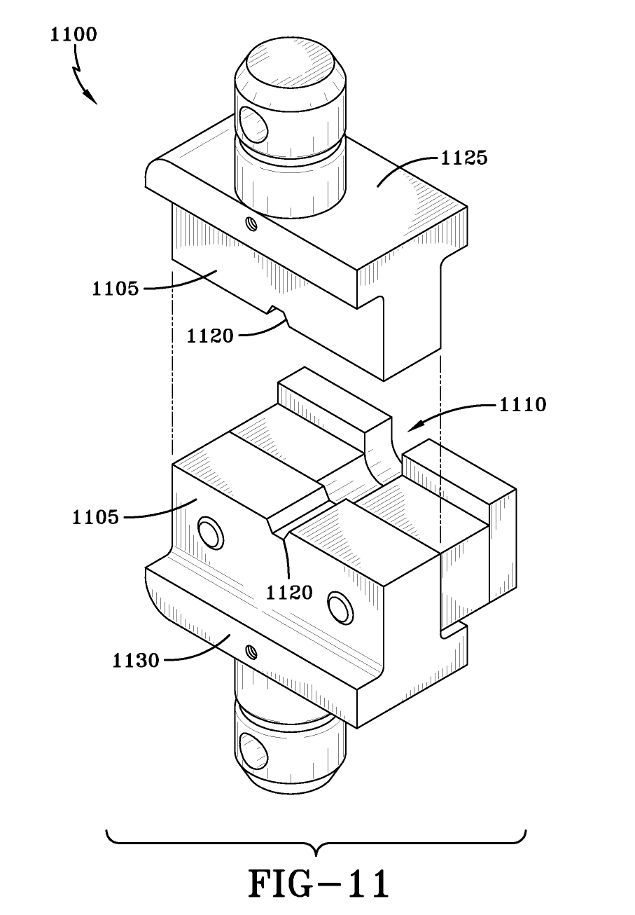

FIG. 11 is a front view perspective of an embodiment of the larger configuration crimp die (1100). This die incorporates only one crimp nest (1120) and is only used for crimping of the 12 AWG crimp ferrule. The center line of the crimp die surface (1120) aligns with the center of the ferrule when the crimp die is fully engaged (i.e. both halves are mechanically pressed together). (1105) shows the crimp die external surface, while (1125) and (1130) illustrate the two crimp die halves. (1110) is the cable locator for the crimp die.

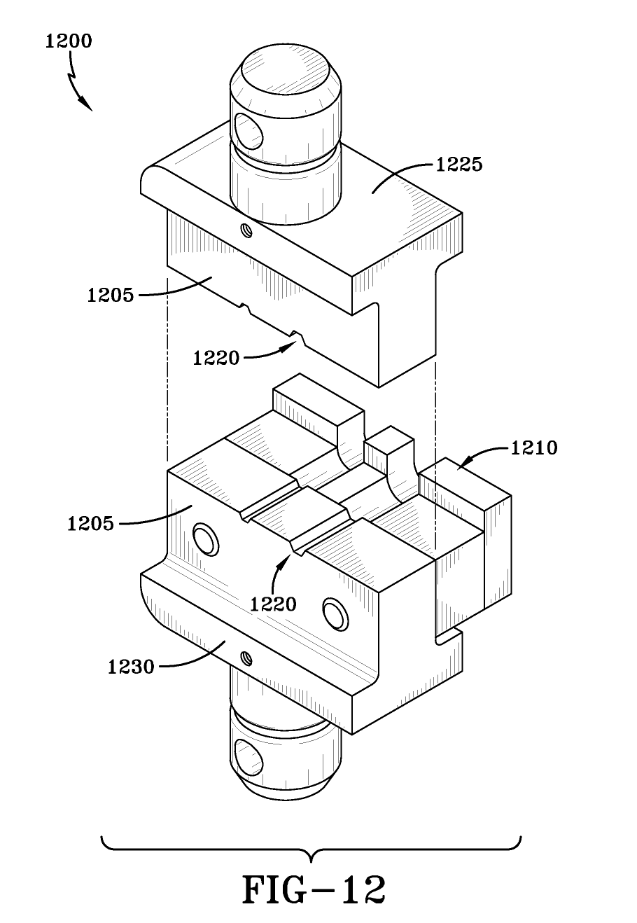

FIG. 12 shows a side view perspective of an embodiment of the crimp die (1200). This embodiment illustrates that the die can be used in the crimping of ferrules in smaller sizes, such as 20, 22, 23, 24 and 28 AWG. The crimp die (1200) includes a notched cable locator (1210) for securing the crimp ferrule in place while crimping. The notched cable locator (1210) enables at least a 4% overlap of the ends of the crimp ferrule. This overlap is required for longitudinal alignment and symmetry. The center line of the crimp surface and the center of the crimp ferrule align (1220) when the die is fully engage (i.e. both halves are mechanically pressed together) are also shown for reference. The crimp die external surface is illustrated by (1205). Also shown are the two dies halves (1225) and (1230).

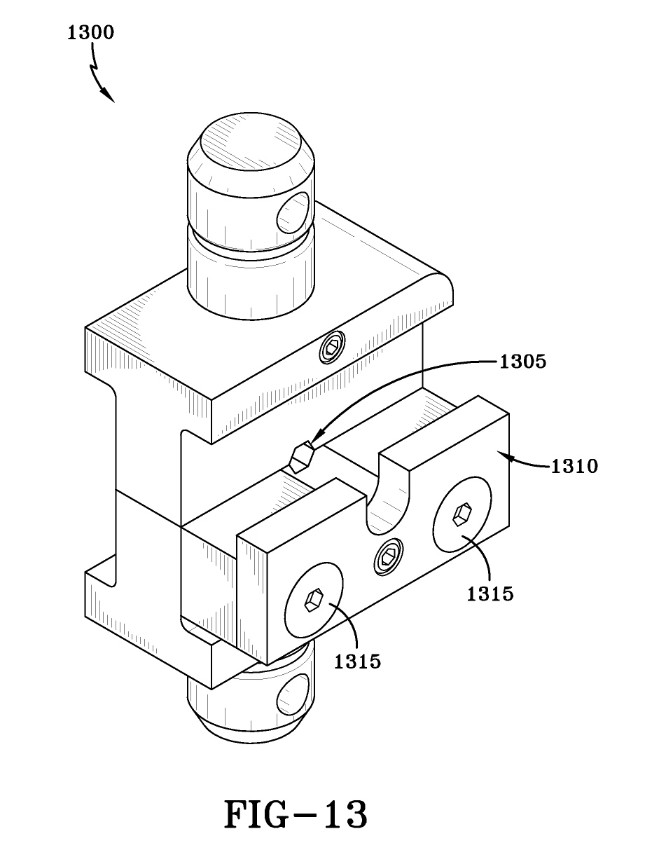

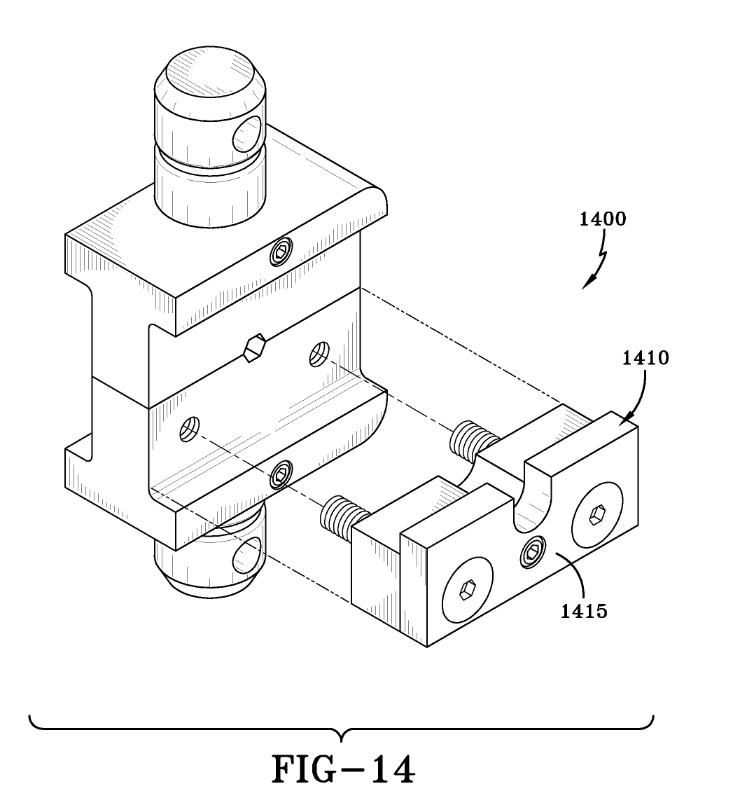

In FIG. 13, a rear view of the crimp die (1300) is shown. The bored size of the hexagonal crimp nest (1305) geometry is dimensioned to accommodate the correct size crimp ferrule (size 12 AWG) with the 12 AWG conductor inserted therein. The crimp die (1300) has a machine tool finish to prevent corrosion and is precision polished on its inner crimp surfaces to ensure a smooth and uniform crimp ferrule surface. Two typical countersunk position mount screws (1315) for securing the positioner are also shown for reference.

Referring to FIG. 14 a side view perspective of the notched cable locator (1400) is shown separately from the crimp die. The die includes a notched cable locator (1410) for securing the ferrule in place while crimping. The notched cable locator (1410) enables at least a 4% overlap of the ends of the crimp ferrule. This overlap is required for longitudinal alignment and symmetry. The notched cable locator (1410) includes the area where the crimp ferrule rests as it is being crimped. Feature (1415) is the mount screw for the position stop gate against which the crimp ferrule rests and the cable is positioned while getting crimped.

What is claimed is:

1. A system for splicing a metallic center conductor of a cable comprising:
a two ended, symmetrically tubed shaped crimp ferrule chamfered at 45 degrees on each end; and
a die set for crimping the two ended, symmetrically tubed shaped crimp ferrule comprising:
a first half with an inner crimping surface having a half symmetrically hexagonal cutout for crimping the two ended symmetrically tube shaped crimp ferrule; and an outer tooled surface for engagement with a crimping tool; and
a second half with an inner crimping surface that fits flush against the inner crimping surface of the first half of the die set, wherein the inner crimping surface of the second half of the die set has a half symmetrically hexagonal cutout that mirrors the half symmetrically hexagonal cutout of the first half of the die set for crimping the two ended symmetrically tubed shaped crimp ferrule, the second half of the of the die set also including an outer tooled surface for engagement with a crimping tool, and a notched cable locator for resting the two ended symmetrically tubed shaped crimp ferrule against while crimping the two ended symmetrically tubed shaped crimp ferrule.

2. The system of claim 1, wherein the two ended, symmetrically tubed shaped crimp ferrule is annealed to facilitate crimping.

3. The system of claim 2, wherein the two ended, symmetrically tubed shaped crimp ferrule has a smooth inner surface throughout its entire length.

4. The system of claim 2, wherein the two ended, symmetrically tubed shaped crimp ferrule comprises one or more holes near its longitudinal center to enable an installer to inspect for adequate metallic center conductor insertion.

5. The system of claim 2, wherein the two ended, symmetrically tubed shaped crimp ferrule is sized both longitudinally and axially to optimize its fit to a metallic center conductor of sizes 12, 20, 22, 23, 24, and 28 American Wire Gages (AWG).

6. The system of claim 1, wherein the notched cable locator has a crimp nest geometry which enables the two ended, symmetrically tubed shaped crimp ferrule to be positioned to enable a minimum of 4% crimp overlap required for longitudinal alignment and symmetry with limited external protrusions.

7. The system of claim 1, wherein the notched cable locator is dimensioned to accurately accommodate cable sizes, for crimp ferrules comprising 12, 20, 22, 23, 24, 28 AWGs.

8. The system of claim 7 wherein the notched cable locator has a protruding length of 0.23 inch and a radius hole of 0.076 inch to accommodate the 20 AWG cable with a 0.056 inch flat to flat dimension.

9. The system of claim 7 wherein the notched cable locator has a protruding length of 0.23 inch and a radius hole of 0.061 inch to accommodate the 22, 23, 24 and 28 AWG cables with a 0.042 inch flat to flat dimension.

10. The system of claim 7 wherein the notched cable locator has a protruding length of 0.23 inch and a radius hole of 0.0146 inch to accommodate the 12 AWG cable with a 0.124 inch flat to flat dimension.

11. The system of claim 1, wherein the two ended, symmetrically tubed shaped crimp ferrule comprises a color band applied axially at its center for identifying specific cable sizes.

12. The system of claim 1, wherein the two ended symmetrically tubed shaped crimp ferrules, after crimping, results in a hexagonal, cross-sectional and longitudinally symmetrical device.

13. The system in claim 1, wherein dimensions of the half symmetrically to hexagonal cutout of the inner crimping surface of the first half of the die set and the half symmetrically hexagonal cutout of the inner crimping surface of the second half of the die set, when pressed together (flat to flat), correlate to dimensions of a corresponding sized two ended, symmetrically tubed shaped crimp ferrule such that when crimped, results in an optimum electrical and mechanical joint.

14. The system of claim 13, wherein, prior to crimping, dimensions of the two ended, symmetrically tubed shaped crimp ferrule has an inner diameter of 0.1 inch, an outer diameter of 0.125 inch and a length of 0.5 inches, and a corresponding crimped, flat to flat dimension of 0.124 to accommodate a 12 AWG cable.

15. The system of claim 13, wherein, prior to crimping, dimensions of the two ended, symmetrically tubed shaped crimp ferrule has an inner diameter of 0.019 inch, an outer diameter of 0.49 inch and a length of 0.5 inches, and a corresponding crimped, flat to flat dimension of 0.042 inch to accommodate a 28 AWG cable.

16. The system of claim 13, wherein, prior to crimping, dimensions of the two ended, symmetrically tubed shaped crimp ferrule has an inner diameter of 0.027 inch, an outer diameter of 0.049 inch and a length of 0.5 inches, and a corresponding crimped, flat to flat dimension of 0.042 to accommodate a 24 AWG cable.

17. The system of claim 13, wherein, prior to crimping, dimensions of the two ended, symmetrically tubed shaped crimp ferrule the two ended, symmetrically tubed shaped crimp ferrule has an inner diameter of 0.028 inch, an outer diameter of 0.049 inch and a length of 0.5 inches, and a corresponding crimped, flat to flat dimension of 0.042 to accommodate a 23 AWG cable.

18. The system of claim 13, wherein, prior to crimping, dimensions of the two ended, symmetrically tubed shaped crimp ferrule has an inner diameter of 0.03 inch, an outer diameter of 0.049 inch and a length of 0.5 inches, and a corresponding crimped, flat to flat dimension of 0.042 inch to accommodate a 22 AWG cable.

19. The system of claim 13, wherein, prior to crimping, dimensions of the two ended, symmetrically tubed shaped crimp ferrule has an inner diameter of 0.042 inch, an outer diameter 0.065 inch and a length of 0.5 inches, and a corresponding crimped, flat to flat dimension of 0.056 inch to accommodate a 20 AWG cable.
